(19) United States
(12) Patent Application Publication
(10) Pub. No.: US 2020/0385306 A1
(43) Pub. Date: Dec. 10, 2020

(54) GLASS SHEETS WITH REDUCED ELECTROSTATIC CHARGE AND METHODS OF PRODUCING THE SAME

(71) Applicant: Corning Incorporated, Corning, NY (US)

(72) Inventor: Jiangwei Feng, Painted Post, NY (US)

(21) Appl. No.: 16/971,804

(22) PCT Filed: Feb. 22, 2019
(86) PCT No.: PCT/US2019/019071

§ 371 Date: Aug. 21, 2020

Related U.S. Application Data
(60) Provisional application No. 62/633,772, filed on Feb. 22, 2018.

(51) Int. Cl. C03C 23/00

(52) U.S. Cl. CPC C03C 23/006

(57) ABSTRACT

A method of manufacturing and treating a glass article wherein the treatment of the article includes directing a flow of plasma, such as a flow of plasma comprising an atmospheric pressure plasma jet, toward a major surface of the article. Such treatment can reduce the absolute measured voltage on the major surface.

This application claims the benefit of priority under 35 U.S.C. § 119 of U.S. Provisional Application Ser. No. 62/633,772 filed on Feb. 22, 2018, the content of which is relied upon and incorporated herein by reference in its entirety.

### FIELD

The present disclosure relates generally to glass sheets with reduced electrostatic charge and methods for producing the same.

### BACKGROUND

In the production of glass articles, such as glass sheets for display applications, including televisions and hand held devices, such as telephones and tablets, there are typically multiple processing steps in which contact between the surface of the glass and other surfaces can generate electrostatic charges on the glass surface. Buildup of such charges on glass surfaces can adversely affect the performance of electronic devices incorporating such glass articles. Accordingly, there is a continuing need to control and reduce electrostatic charge generation on glass articles used, for example, in display applications and other electronic devices.

### SUMMARY

Embodiments disclosed herein include a method for manufacturing a glass article. The method includes forming the glass article. The glass article includes a first major surface, a second major surface parallel to the first major surface, and an edge surface extending between the first major surface and the second major surface in a direction perpendicular to the first and second major surfaces. The method also includes directing a flow of plasma toward the first major surface. Direction of the flow of plasma toward the first major surface reduces the absolute measured voltage on the first major surface by at least about 35% and changes the average surface roughness, Ra, of the first major surface by less than about 20%.

Embodiments disclosed herein also include a method for treating a glass article. The glass article includes a first major surface, a second major surface parallel to the first major surface, and an edge surface extending between the first major surface and the second major surface in a direction perpendicular to the first and second major surfaces. The method includes directing a flow of plasma toward the first major surface. Direction of the flow of plasma toward the first major surface reduces the absolute measured voltage on the first major surface by at least about 35% and changes the average surface roughness, Ra, of the first major surface by less than about 20%.

Embodiments disclosed herein also include a glass article. The glass article includes a first major surface, a second major surface parallel to the first major surface, and an edge surface extending between the first major surface and the second major surface in a direction perpendicular to the first and second major surfaces. An absolute measured voltage on the first major surface is less than about 0.25 kV and an average surface roughness, Ra, of the first major surface is less than about 0.3 nm.

Additional features and advantages of the embodiments disclosed herein will be set forth in the detailed description which follows, and in part will be readily apparent to those skilled in the art from that description or recognized by practicing the disclosed embodiments as described herein, including the detailed description which follows, the claims, as well as the appended drawings.

It is to be understood that both the foregoing general description and the following detailed description present embodiments intended to provide an overview or framework for understanding the nature and character of the claimed embodiments. The accompanying drawings are included to provide further understanding, and are incorporated into and constitute a part of this specification. The drawings illustrate various embodiments of the disclosure, and together with the description serve to explain the principles and operations thereof.

### BRIEF DESCRIPTION OF THE DRAWINGS

FIG. 1 is a schematic view of an example fusion down draw glass making apparatus and process;

FIG. 2 is an perspective view of a glass sheet;

FIG. 3 is a perspective view of at least a portion of a major surface treatment process with a plasma jet;

FIG. 4 is a schematic front view of a major surface treatment with a plasma jet;

FIG. 5 is a perspective view of at least a portion of a major surface treatment with a linear plasma flow; and

FIG. 6 is a schematic front view of a major surface treatment with a linear plasma flow.

### DETAILED DESCRIPTION

Reference will now be made in detail to the present preferred embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, for example by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom—are made only with reference to the figures as drawn and are not intended to imply absolute orientation.

Unless otherwise expressly stated, it is in no way intended that any method set forth herein be construed as requiring that its steps be performed in a specific order, nor that with any apparatus specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an” and “the” include plural referents unless the context clearly dictates otherwise. Thus, for example, reference to “a” component includes aspects having two or more such components, unless the context clearly indicates otherwise.

As used herein, the term “plasma” refers to an ionized gas comprising positive ions and free electrons.

As used herein, the term “atmospheric” when referring to atmospheric pressure plasma jet or linear atmospheric pressure plasma flow refers to a flow of plasma discharged from an aperture, wherein the plasma pressure approximately matches that of the surrounding atmosphere, including conditions wherein the plasma pressure is between 90% and 110% of 101.325 kilopascals (standard atmospheric pressure).

As used herein, the term “absolute measured voltage” refers to the absolute value of voltage measured by the voltage measurement technique (VMT) as described in the Examples section herein. Accordingly, the term “reduces the absolute measured voltage” refers to reducing the absolute value of the measured voltage as measured by the VMT as described in the Examples section herein.

As used herein, the term “surface roughness, Ra” refers to arithmetical mean surface roughness as set forth in JIS B 0031 (1994).

As used herein, the term “clean dry air” (CDA) refers to air comprising less than one gram of water vapor per kilogram of air.

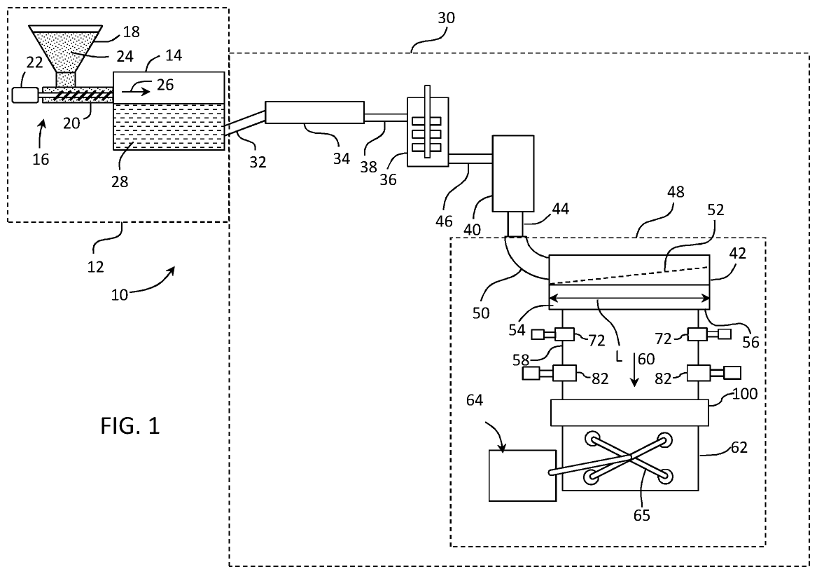

Shown in FIG. 1 is an exemplary glass manufacturing apparatus 10. In some examples, the glass manufacturing apparatus 10 can comprise a glass melting furnace 12 that can include a melting vessel 14. In addition to melting vessel 14, glass melting furnace 12 can optionally include one or more additional components such as heating elements (e.g., combustion burners or electrodes) that heat raw materials and convert the raw materials into molten glass. In further examples, glass melting furnace 12 may include thermal management devices (e.g., insulation components) that reduce heat lost from a vicinity of the melting vessel. In still further examples, glass melting furnace 12 may include electronic devices and/or electromechanical devices that facilitate melting of the raw materials into a glass melt. Still further, glass melting furnace 12 may include support structures (e.g., support chassis, support member, etc.) or other components.

Glass melting vessel 14 is typically comprised of refractory material, such as a refractory ceramic material, for example a refractory ceramic material comprising alumina or zirconia. In some examples glass melting vessel 14 may be constructed from refractory ceramic bricks. Specific embodiments of glass melting vessel 14 will be described in more detail below.

In some examples, the glass melting furnace may be incorporated as a component of a glass manufacturing apparatus to fabricate a glass substrate, for example a glass ribbon of a continuous length. In some examples, the glass melting furnace of the disclosure may be incorporated as a component of a glass manufacturing apparatus comprising a slot draw apparatus, a float bath apparatus, a down-draw apparatus such as a fusion process, an up-draw apparatus, a press-rolling apparatus, a tube drawing apparatus or any other glass manufacturing apparatus that would benefit from the aspects disclosed herein. By way of example, FIG. 1 schematically illustrates glass melting furnace 12 as a component of a fusion down-draw glass manufacturing apparatus 10 for fusion drawing a glass ribbon for subsequent processing into individual glass sheets.

The glass manufacturing apparatus 10 (e.g., fusion down-draw apparatus 10 ) can optionally include an upstream glass manufacturing apparatus 16 that is positioned upstream relative to glass melting vessel 14. In some examples, a portion of, or the entire upstream glass manufacturing apparatus 16, may be incorporated as part of the glass melting furnace 12.

As shown in the illustrated example, the upstream glass manufacturing apparatus 16 can include a storage bin 18, a raw material delivery device 20 and a motor 22 connected to the raw material delivery device. Storage bin 18 may be configured to store a quantity of raw materials 24 that can be fed into melting vessel 14 of glass melting furnace 12, as indicated by arrow 26. Raw materials 24 typically comprise one or more glass forming metal oxides and one or more modifying agents. In some examples, raw material delivery device 20 can be powered by motor 22 such that raw material delivery device 20 delivers a predetermined amount of raw materials 24 from the storage bin 18 to melting vessel 14. In further examples, motor 22 can power raw material delivery device 20 to introduce raw materials 24 at a controlled rate based on a level of molten glass sensed downstream from melting vessel 14. Raw materials 24 within melting vessel 14 can thereafter be heated to form molten glass 28.

Glass manufacturing apparatus 10 can also optionally include a downstream glass manufacturing apparatus 30 positioned downstream relative to glass melting furnace 12. In some examples, a portion of downstream glass manufacturing apparatus 30 may be incorporated as part of glass melting furnace 12. In some instances, first connecting conduit 32 discussed below, or other portions of the downstream glass manufacturing apparatus 30, may be incorporated as part of glass melting furnace 12. Elements of the downstream glass manufacturing apparatus, including first connecting conduit 32, may be formed from a precious metal. Suitable precious metals include platinum group metals selected from the group of metals consisting of platinum, iridium, rhodium, osmium, ruthenium and palladium, or alloys thereof. For example, downstream components of the glass manufacturing apparatus may be formed from a platinum-rhodium alloy including from about 70 to about 90% by weight platinum and about 10% to about 30% by weight rhodium. However, other suitable metals can include molybdenum, palladium, rhenium, tantalum, titanium, tungsten and alloys thereof.

Downstream glass manufacturing apparatus 30 can include a first conditioning (i.e., processing) vessel, such as fining vessel 34, located downstream from melting vessel 14 and coupled to melting vessel 14 by way of the above-referenced first connecting conduit 32. In some examples, molten glass 28 may be gravity fed from melting vessel 14 to fining vessel 34 by way of first connecting conduit 32. For instance, gravity may cause molten glass 28 to pass through an interior pathway of first connecting conduit 32 from melting vessel 14 to fining vessel 34. It should be understood, however, that other conditioning vessels may be positioned downstream of melting vessel 14, for example between melting vessel 14 and fining vessel 34. In some embodiments, a conditioning vessel may be employed between the melting vessel and the fining vessel wherein molten glass from a primary melting vessel is further heated to continue the melting process, or cooled to a temperature lower than the temperature of the molten glass in the melting vessel before entering the fining vessel.

Bubbles may be removed from molten glass 28 within fining vessel 34 by various techniques. For example, raw materials 24 may include multivalent compounds (i.e. fining agents) such as tin oxide that, when heated, undergo a chemical reduction reaction and release oxygen. Other suitable fining agents include without limitation arsenic, antimony, iron and cerium. Fining vessel 34 is heated to a temperature greater than the melting vessel temperature, thereby heating the molten glass and the fining agent. Oxygen bubbles produced by the temperature-induced chemical reduction of the fining agent(s) rise through the molten glass within the fining vessel, wherein gases in the molten glass produced in the melting furnace can diffuse or coalesce into the oxygen bubbles produced by the fining agent. The enlarged gas bubbles can then rise to a free surface of the molten glass in the fining vessel and thereafter be vented out of the fining vessel. The oxygen bubbles can further induce mechanical mixing of the molten glass in the fining vessel.

Downstream glass manufacturing apparatus 30 can further include another conditioning vessel such as a mixing vessel 36 for mixing the molten glass. Mixing vessel 36 may be located downstream from the fining vessel 34. Mixing vessel 36 can be used to provide a homogenous glass melt composition, thereby reducing cords of chemical or thermal inhomogeneity that may otherwise exist within the fined molten glass exiting the fining vessel. As shown, fining vessel 34 may be coupled to mixing vessel 36 by way of a second connecting conduit 38. In some examples, molten glass 28 may be gravity fed from the fining vessel 34 to mixing vessel 36 by way of second connecting conduit 38. For instance, gravity may cause molten glass 28 to pass through an interior pathway of second connecting conduit 38 from fining vessel 34 to mixing vessel 36. It should be noted that while mixing vessel 36 is shown downstream of fining vessel 34, mixing vessel 36 may be positioned upstream from fining vessel 34. In some embodiments, downstream glass manufacturing apparatus 30 may include multiple mixing vessels, for example a mixing vessel upstream from fining vessel 34 and a mixing vessel downstream from fining vessel 34. These multiple mixing vessels may be of the same design, or they may be of different designs.

Downstream glass manufacturing apparatus 30 can further include another conditioning vessel such as delivery vessel 40 that may be located downstream from mixing vessel 36. Delivery vessel 40 may condition molten glass 28 to be fed into a downstream forming device. For instance, delivery vessel 40 can act as an accumulator and/or flow controller to adjust and/or provide a consistent flow of molten glass 28 to forming body 42 by way of exit conduit 44. As shown, mixing vessel 36 may be coupled to delivery vessel 40 by way of third connecting conduit 46. In some examples, molten glass 28 may be gravity fed from mixing vessel 36 to delivery vessel 40 by way of third connecting conduit 46. For instance, gravity may drive molten glass 28 through an interior pathway of third connecting conduit 46 from mixing vessel 36 to delivery vessel 40.

Downstream glass manufacturing apparatus 30 can further include forming apparatus 48 comprising the above-referenced forming body 42 and inlet conduit 50. Exit conduit 44 can be positioned to deliver molten glass 28 from delivery vessel 40 to inlet conduit 50 of forming apparatus 48. For example, exit conduit 44 may be nested within and spaced apart from an inner surface of inlet conduit 50, thereby providing a free surface of molten glass positioned between the outer surface of exit conduit 44 and the inner surface of inlet conduit 50. Forming body 42 in a fusion down draw glass making apparatus can comprise a trough 52 positioned in an upper surface of the forming body and converging forming surfaces 54 that converge in a draw direction along a bottom edge 56 of the forming body. Molten glass delivered to the forming body trough via delivery vessel 40, exit conduit 44 and inlet conduit 50 overflows side walls of the trough and descends along the converging forming surfaces 54 as separate flows of molten glass. The separate flows of molten glass join below and along bottom edge 56 to produce a single ribbon of glass 58 that is drawn in a draw or flow direction 60 from bottom edge 56 by applying tension to the glass ribbon, such as by gravity, edge rolls 72 and pulling rolls 82, to control the dimensions of the glass ribbon as the glass cools and a viscosity of the glass increases. Accordingly, glass ribbon 58 goes through a visco-elastic transition and acquires mechanical properties that give the glass ribbon 58 stable dimensional characteristics. Glass ribbon 58 may, in some embodiments, be separated into individual glass sheets 62 by a glass separation apparatus 100 in an elastic region of the glass ribbon. A robot 64 may then transfer the individual glass sheets 62 to a conveyor system using gripping tool 65, whereupon the individual glass sheets may be further processed.

Glass sheets 62 may further be separated into individual glass tiles by one or more methods known to persons of ordinary skill in the art such as, for example, a mechanical cutting technique. Exemplary cutting techniques include, for example, use of a semiconductor dicing saw or a mechanical scribe. Glass sheets 63 may also be separated into individual glass tiles by other techniques, such as, for example, laser-based cutting and separation techniques.

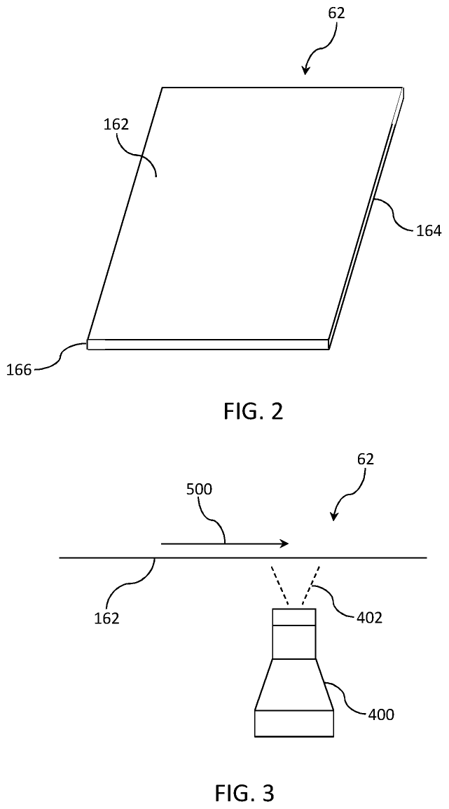

FIG. 2 shows a perspective view of a glass sheet 62 having a first major surface 162, a second major surface 164 extending in a generally parallel direction to the first major surface (on the opposite side of the glass sheet 62 as the first major surface) and an edge surface 166 extending between the first major surface and the second major surface and extending in a generally perpendicular direction to the first and second major surfaces 162, 164.

FIG. 3 shows a perspective view of at least a portion of a treatment process of first major surface 162 of glass sheet 62 with a plasma jet 402. As shown in FIG. 3, treatment process includes directing a flow of plasma, via plasma jet 402, toward first major surface 162, wherein plasma jet head 400 moves relative to first major surface 162 in the direction indicated by arrow 500. In certain exemplary embodiments, plasma jet 402 comprises an atmospheric pressure plasma jet.

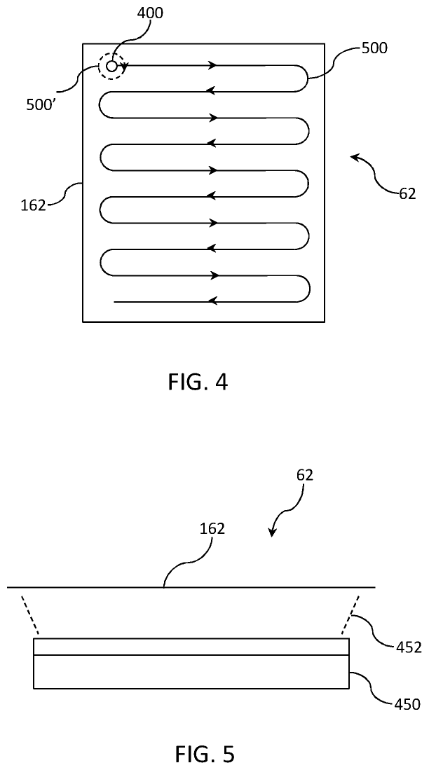

FIG. 4 shows a schematic front view of a major surface treatment with a plasma jet 402. As shown in FIG. 4, plasma jet head 400 moves across first major surface 162 of glass sheet 62 in the direction indicated by arrow 500. Specifically, plasma jet head 400 alternates moving from left to right and then from right to left in the process of moving down the sheet as viewed from the perspective shown in FIG. 4. Plasma jet head 400 may also rotate in direction indicated by dashed arrow 500′ while generally moving in the direction indicated by arrow 500. While dashed arrow 500′ shows a generally circular clockwise movement, it is to be understood that embodiments disclosed herein comprise other plasma jet head 400 movements, such as a generally circular counterclockwise movement, as well as clockwise or counterclockwise movements in other shapes, such as elliptical or polygonal.

Plasma jet 402 can be directed toward first major surface 162 under a variety of processing parameters. In certain exemplary embodiments, plasma jet 402 can be generated at a power of at least about 300 watts, such as a power of at least about 500 watts, including a power of from about 300 watts to about 800 watts and further including a power of from about 500 watts to about 700 watts.

In certain exemplary embodiments, plasma jet 402 is generated via a direct current high voltage discharge that generates a pulsed electric arc, such as a voltage discharge of at least about 5 kV, such as from about 5 kV to about 15 kV. In certain exemplary embodiments, plasma jet 402 is generated at a frequency of at least about 10 kHz, such as from about 10 kHz to about 100 kHz, and further such as from about 30 kHz to about 70 kHz. In certain exemplary embodiments, plasma jet can have a beam length of from about 5 millimeters to about 40 millimeters and a widest beam width of from about 0.5 millimeters to about 15 millimeters.

In certain exemplary embodiments, the distance between the portion of plasma jet head 400 that is closest to first major surface 162 (referred to herein as “gap distance”), is at least about 1 millimeter, such as at least about 5 millimeters, and further such as at least about 10 millimeters, such as from about 1 millimeter to about 25 millimeters, including from about 5 millimeters to about 20 millimeters.

In certain exemplary embodiments, the speed of relative movement between plasma jet head 400 and first major surface 162 (referred to herein as “scan speed”) can range from about 5 millimeters per second to about 250 millimeters per second, such as from about 10 millimeters per second to about 200 millimeters per second, and further such as from about 50 millimeters per second to about 150 millimeters per second.

FIG. 5 shows a perspective view of at least a portion of a treatment process of first major surface 162 of glass sheet 62 with a linear plasma flow 452. As shown in FIG. 5, treatment process includes directing a flow of plasma, via linear plasma flow 452, toward first major surface 162, via linear plasma device 450. In certain exemplary embodiments, linear plasma flow 452 comprises a linear atmospheric pressure plasma flow.

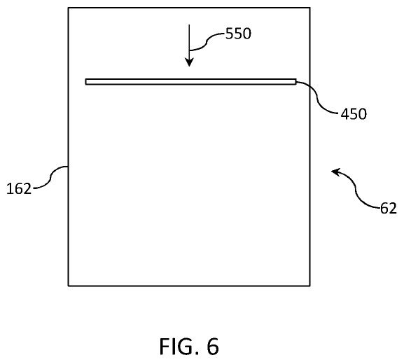

FIG. 6 shows a schematic front view of a major surface treatment with a linear plasma flow 452. As shown in FIG. 6, linear plasma device 450 moves across first major surface 162 of glass sheet 62 in the direction indicated by arrow 550 (such movement of linear plasma device across first major surface 162 of glass sheet 62 is herein referred to as a “scan”).

In certain exemplary embodiments, liner plasma device 450 may scan first major surface 162 of glass sheet 62 at least once, such as from 1 to 10 times, and further such as from 2 to 6 times. When linear plasma device 450 scans first major surface 162 of glass sheet 62 more than one time, it may, for example, move in the direction of arrow 550 on odd numbered scans and in an opposite direction as indicated by arrow 550 on even numbered scans.

Linear plasma flow 452 can be directed toward first major surface 162 under a variety of processing parameters. In certain exemplary embodiments, linear plasma flow 452 can be generated at a power of at least about 300 watts, such as a power of at least about 500 watts, including a power of from about 300 watts to about 800 watts and further including a power of from about 500 watts to about 700 watts.

In certain exemplary embodiments, linear plasma flow 452 is generated via a direct barrier discharge at a frequency of at least about 1 MHz, such as from about 1 MHz to about 25 MHz, and further such as from about 5 MHz to about 15 MHz.

In certain exemplary embodiments, the gap distance between the portion of linear plasma device 450 that is closest to first major surface 162 is at least about 1 millimeter, such as at least about 5 millimeters, and further such as at least about 10 millimeters, such as from about 1 millimeter to about 25 millimeters, including from about 5 millimeters to about 20 millimeters.

In certain exemplary embodiments, the scan speed between linear plasma device 450 and first major surface 162 can range from about 1 millimeter per second to about 100 millimeters per second, such as from about 10 millimeters per second to about 70 millimeters per second, and further such as from about 20 millimeters per second to about 40 millimeters per second.

While FIGS. 3-6 show directing a flow of plasma, via either plasma jet 402 or linear flow 452, toward first major surface 162 of glass sheet 62, it is to be understood that embodiments disclosed herein include those in which flow of plasma, via either plasma jet 402 or linear flow 452, are directed toward second major surface 164 of glass sheet 62, such as those in which flow of plasma is directed toward both first major surface 162 and second major surface 164 of glass sheet 62. For example, embodiments disclosed herein include those in which a flow of plasma, via either an atmospheric plasma jet or an atmospheric linear flow, is directed, simultaneously or separately, toward both first major surface 162 and second major surface 164 of glass sheet 62.

In certain exemplary embodiments, at least one of first major surface 162 and second major surface 164 may be heated, for example, by an electrical resistance heater or an induction heater, to a temperature of at least about 100° C., such as at least about 200° C., and further such as at least about 300° C., and yet further such as at least about 400° C., and still yet further such as at least about 500° C., including a temperature ranging from about 100° C. to about 600° C. prior to directing the flow of plasma toward the major surface. Exemplary embodiments also include those in which temperature of the major surface is maintained in the above-referenced ranges for a period of time subsequent to directing a flow of plasma toward the major surface.

In certain exemplary embodiments, the plasma, via either plasma jet 402 or linear flow 452, comprises at least one component, such as at least two components, and further such as at least three components selected from the group consisting of nitrogen, argon, oxygen, helium, and CDA that is excited and at least partially converted to the plasma state. In certain exemplary embodiments, the plasma comprises nitrogen and at least one component selected from the group consisting of argon, oxygen, helium, and CDA. In certain exemplary embodiments, the plasma comprises nitrogen and at least one component selected from argon and helium.

In certain exemplary embodiments, the plasma, via either plasma jet 402 or linear flow 452, comprises at least about 80 mol % nitrogen, such as from about 80 mol % to about 100 mol % nitrogen and further such as from about 85 mol % to about 95 mol % of nitrogen. In certain exemplary embodiments, the plasma comprises at least about 80 mol % nitrogen and at least 2 mol %, such as at least 5 mol %, of at least one component selected from the group consisting of argon, oxygen, helium, and CDA. In certain exemplary embodiments, the plasma comprises at least about 80 mol % nitrogen at least 2 mol %, such as at least 5 mol %, of at least one component selected from the group consisting of argon and helium.

In certain exemplary embodiments, the plasma, via either plasma jet 402 or linear flow 452, is substantially free of a component known to those of skill in the art to substantially etch glass, such as substantially free of an acid etchant. In certain exemplary embodiments, the plasma, via either plasma jet 402 or linear flow 452, is substantially free of fluorine, including any compound containing fluorine. For example, embodiments disclosed herein include those in which the plasma, via either plasma jet 402 or linear flow 452, is substantially free of HF, CF₄, and SF₆.

Direction of the flow of plasma, via either plasma jet 402 or linear flow 452, toward the first major surface 162 in accordance with embodiments herein can reduce the absolute measured voltage on the first major surface by at least about 35%, such as at least about 40%, and further such as at least about 50%, and yet further such as least about 100% as compared to a glass surface that has not been subjected to plasma treatment.

For example, direction of the flow of plasma, via either plasma jet 402 or linear flow 452, toward the first major surface 162 in accordance with embodiments herein can result in an absolute measured voltage on the first major surface 162 that is less than about 0.25 kV, such as less than about 0.20 kV, and further such as less than about 0.15 kV, and yet further such as less than about 0.10 kV, and still yet further such as less than about 0.05 kV, including from about 0 kV to about 0.25 kV, and further including from about 0.05 kV to about 0.20 kV, and still yet further including from about 0.10 kV to about 0.15 kV.

In addition, direction of the flow of plasma, via either plasma jet 402 or linear flow 452, toward the first major surface 162 in accordance with embodiments herein can change the average surface roughness, Ra, of the first major surface by less than about 20%, such as by less than about 15%, and further such as less than about 10%, and yet further such as less than about 5%, including from about 0% to about 20%, and further including from about 5% to about 15%.

For example, direction of the flow of plasma, via either plasma jet 402 or linear flow 452, toward the first major surface 162 in accordance with embodiments herein can result in an average surface roughness, Ra, of the first major surface 162 that is less than about 0.3 nm, such as less than about 0.25 nm, including from about 0.15 nm to about 0.3 nm, and further including from about 0.20 nm to about 0.25 nm.

### EXAMPLES

Embodiments herein are further illustrated with reference to the following non-limiting examples:

### Example 1

Samples of Eagle XG® glass sheets having a thickness of about 0.5 millimeters and first and second major surface dimensions of about 100 millimeters by about 100 millimeters were subjected to major surface treatment either by atmospheric pressure plasma jet or by linear atmospheric pressure plasma flow by as set forth in Table 1. Prior to atmospheric plasma surface treatment, each sample was washed with an aqueous solution containing about 2.5 wt % Parker250 or Semiclean KG detergent available from Parker Hannifin followed by six quick dump rinses (QDR) in deionized water.

Each sample having a major surface treated with atmospheric pressure plasma jet (referred to as “jet” in Table 1) was scanned in a similar manner as illustrated in FIG. 4 with a plasma head scan speed of about 100 millimeters per second with an AC power source with a frequency of about 50 KHz, and a power ranging from about 500 to about 650 watts.

Each sample having a major surface treated with linear atmospheric pressure plasma flow (referred to as “linear” in Table 1) was scanned in a similar manner as illustrated in FIG. 6 with a scan speed of about 30 millimeters per second, with four scans per sample, using a 13.56 MHz power source and a power ranging from about 550 to about 650 watts.

The gap distance (referred to as “gap” in Table 1) was allowed to vary for the various treatments as was the plasma composition and flow rate in standard liters per minute (SLM) as set forth in Table 1.

Voltage measurement technique (VMT)

The measured voltage on the major surface of each treated sample was determined using a voltage measurement technique (VMT) in which each sample was separated from a stainless steel vacuum table exerting a relative negative pressure of about 20 Pa and having at least the same surface area as the treated surface of the sample at a separation rate of about 10 millimeters per second. Once the sample and the vacuum table were separated by a distance of about 80 millimeters, a voltage measurement was taken using a Monroe Electronics electrostatic field meter at a distance of about one inch from the sample. This measurement is referred to in Table 1 as V80. Following this measurement, the 80 millimeter distance between the sample and the vacuum table was maintained and a second measurement was taken approximately 1 minute later, referred to in Table 1 as Vsteady.

The results of the treatments are set forth in Table 1 (wherein the absolute measured voltage is the absolute value of each measured voltage reported in the table). An untreated control sample of Eagle XG® glass was also subjected to the VMT described above and had a major surface measured voltage of about −0.35 kV (corresponding to a major surface absolute measured voltage of about 0.35 kV).

TABLE 1

| | | | | | | | | Total | | |
|---|---|---|---|---|---|---|---|---|---|---|
| | | Gap | Power | Ar | N2 | He | O2 | flow | Vsteady | V 80/ |
| N | Type | (mm) | (W) | (SLM) | (SLM) | (SLM) | (SLM) | (SLM) | (kV) | Vsteady |
| 1 | linear | 17 | 550 | 0 | 0 | 15 | 0 | 15 | −0.151 | 1.136 |
| 2 | linear | 17 | 550 | 12 | 0 | 3 | 10 | 25 | −0.087 | 1.151 |
| 3 | linear | 19 | 550 | 12 | 70 | 3 | 0 | 85 | −0.200 | 1.077 |
| 4 | linear | 19 | 650 | 12 | 35 | 3 | 0 | 50 | −0.199 | 1.126 |
| 5 | linear | 19 | 600 | 0 | 0 | 15 | 0 | 15 | −0.234 | 1.137 |
| 6 | linear | 19 | 650 | 12 | 0 | 3 | 0.2 | 15.2 | −0.262 | 1.069 |
| 7 | linear | 15 | 650 | 12 | 0 | 3 | 0.2 | 15.2 | −0.200 | 1.110 |
| 8 | linear | 15 | 650 | 12 | 0 | 3 | 20 | 35 | −0.103 | 1.064 |
| 9 | linear | 19 | 600 | 12 | 0 | 3 | 0.1 | 15.1 | −0.181 | 1.067 |
| 10 | linear | 15 | 550 | 15 | 0 | 0 | 0 | 15 | −0.145 | 1.082 |
| 11 | linear | 15 | 550 | 12 | 35 | 3 | 0 | 50 | −0.193 | 1.162 |
| 12 | linear | 15 | 550 | 12 | 0 | 3 | 20 | 35 | −0.112 | 1.064 |
| 13 | linear | 19 | 650 | 12 | 0 | 3 | 20 | 35 | −0.110 | 1.041 |
| 14 | linear | 15 | 550 | 12 | 70 | 3 | 0 | 85 | −0.190 | 1.126 |
| 15 | linear | 15 | 600 | 0 | 0 | 15 | 0 | 15 | −0.218 | 1.117 |
| 16 | linear | 15 | 650 | 12 | 0 | 3 | 10 | 25 | −0.133 | 1.083 |
| 17 | linear | 19 | 550 | 12 | 35 | 3 | 0 | 50 | −0.194 | 1.091 |
| 18 | linear | 15 | 550 | 12 | 0 | 3 | 0.1 | 15.1 | −0.200 | 1.150 |
| 19 | linear | 17 | 650 | 15 | 0 | 0 | 0 | 15 | −0.117 | 1.057 |
| 20 | linear | 19 | 550 | 15 | 0 | 0 | 0 | 15 | −0.159 | 1.068 |
| 21 | linear | 19 | 650 | 12 | 70 | 3 | 0 | 85 | −0.219 | 1.081 |
| 22 | linear | 19 | 650 | 12 | 0 | 3 | 10 | 25 | −0.114 | 1.072 |
| 23 | linear | 19 | 550 | 12 | 0 | 3 | 20 | 35 | −0.121 | 1.050 |
| 24 | linear | 15 | 650 | 12 | 70 | 3 | 0 | 85 | −0.212 | 1.117 |
| 25 | linear | 15 | 650 | 12 | 0 | 3 | 0.1 | 15.1 | −0.214 | 1.082 |
| 26 | linear | 15 | 650 | 12 | 35 | 3 | 0 | 50 | −0.181 | 1.137 |
| 27 | linear | 17 | 550 | 12 | 0 | 3 | 0.2 | 15.2 | −0.210 | 1.108 |
| 28 | linear | 17 | 650 | 0 | 0 | 15 | 0 | 15 | −0.263 | 1.101 |
| 29 | linear | 17 | 600 | 12 | 70 | 3 | 0 | 85 | −0.214 | 1.149 |
| 30 | linear | 17 | 600 | 12 | 35 | 3 | 0 | 50 | −0.173 | 1.081 |
| 31 | linear | 17 | 600 | 12 | 0 | 3 | 20 | 35 | −0.117 | 1.043 |
| 32 | linear | 17 | 600 | 12 | 0 | 3 | 10 | 25 | −0.143 | 1.102 |
| 33 | jet | 9 | 650 | 0 | 40 | 5 | 5 | 50 | −0.050 | 1.014 |
| 34 | jet | 15 | 650 | 0 | 40 | 5 | 0 | 45 | −0.047 | 1.022 |
| 35 | jet | 9 | 500 | 1 | 44 | 0 | 0 | 45 | 0.067 | 1.070 |
| 36 | jet | 9 | 575 | 0 | 45 | 0 | 0 | 45 | −0.075 | 1.009 |
| 37 | jet | 9 | 650 | 5 | 40 | 0 | 0 | 45 | −0.060 | 0.996 |
| 38 | jet | 15 | 500 | 0 | 40 | 5 | 0 | 45 | −0.087 | 1.050 |
| 39 | jet | 9 | 500 | 0 | 44 | 1 | 0 | 45 | −0.091 | 0.998 |
| 40 | jet | 12 | 500 | 0 | 40 | 5 | 5 | 50 | −0.071 | 0.996 |
| 41 | jet | 15 | 650 | 1 | 44 | 0 | 0 | 45 | −0.074 | 1.000 |
| 42 | jet | 15 | 500 | 0 | 45 | 0 | 0 | 45 | −0.082 | 1.012 |
| 43 | jet | 15 | 500 | 5 | 40 | 0 | 0 | 45 | 0.014 | 1.107 |
| 44 | jet | 15 | 575 | 0 | 40 | 0 | 5 | 45 | −0.109 | 1.033 |
| 45 | jet | 15 | 575 | 0 | 45 | 0 | 0 | 45 | −0.107 | 1.012 |
| 46 | jet | 9 | 650 | 1 | 44 | 0 | 0 | 45 | −0.087 | 1.014 |
| 47 | jet | 15 | 575 | 0 | 44 | 1 | 0 | 45 | −0.105 | 1.000 |
| 48 | jet | 9 | 500 | 0 | 44 | 0 | 1 | 45 | −0.107 | 1.046 |
| 49 | jet | 9 | 500 | 5 | 40 | 0 | 0 | 45 | −0.030 | 0.994 |
| 50 | jet | 9 | 500 | 0 | 45 | 0 | 0 | 45 | −0.118 | 1.019 |
| 51 | jet | 9 | 500 | 0 | 40 | 5 | 0 | 45 | −0.060 | 1.002 |
| 52 | jet | 15 | 500 | 0 | 44 | 0 | 1 | 45 | −0.118 | 1.012 |
| 53 | jet | 12 | 650 | 0 | 40 | 0 | 5 | 45 | −0.099 | 1.041 |
| 54 | jet | 15 | 500 | 1 | 44 | 0 | 0 | 45 | −0.100 | 1.002 |
| 55 | jet | 9 | 650 | 0 | 44 | 1 | 0 | 45 | −0.100 | 1.000 |
| 56 | jet | 15 | 650 | 0 | 40 | 5 | 0 | 50 | −0.083 | 1.000 |
| 57 | jet | 12 | 650 | 0 | 45 | 0 | 0 | 45 | −0.113 | 1.036 |
| 58 | jet | 12 | 650 | 5 | 40 | 0 | 0 | 45 | −0.048 | 1.003 |
| 59 | jet | 12 | 500 | 0 | 40 | 0 | 5 | 45 | −0.107 | 1.036 |
| 60 | jet | 12 | 650 | 0 | 44 | 0 | 1 | 45 | −0.130 | 1.049 |
| 61 | jet | 12 | 575 | 1 | 44 | 0 | 0 | 45 | −0.097 | 1.010 |
| 62 | jet | 12 | 575 | 0 | 40 | 5 | 5 | 50 | −0.079 | 1.002 |
| 63 | jet | 12 | 575 | 0 | 40 | 5 | 0 | 45 | −0.087 | 1.004 |
| 64 | jet | 12 | 575 | 0 | 44 | 1 | 0 | 45 | −0.106 | 1.011 |

While the above embodiments have been described with reference to a fusion down draw process, it is to be understood that such embodiments are also applicable to other glass forming processes, such as float processes, slot draw processes, up-draw processes, tube drawing processes, and press-rolling processes.

It will be apparent to those skilled in the art that various modifications and variations can be made to embodiment of the present disclosure without departing from the spirit and scope of the disclosure. Thus it is intended that the present disclosure cover such modifications and variations provided they come within the scope of the appended claims and their equivalents.

What is claimed is:

1. A method for manufacturing a glass article comprising:
forming the glass article comprising a first major surface, a second major surface parallel to the first major surface, and an edge surface extending between the first major surface and the second major surface in a direction perpendicular to the first and second major surfaces; and
directing a flow of plasma toward the first major surface, wherein direction of the flow of plasma toward the first major surface reduces the absolute measured voltage on the first major surface by at least about 35% and changes the average surface roughness, Ra, of the first major surface by less than about 20%.

2. The method of claim 1, wherein the flow of plasma comprises an atmospheric pressure plasma jet.

3. The method of claim 1, wherein the flow of plasma comprises an atmospheric pressure liner flow.

4. The method of claim 1, wherein the plasma comprises at least one component selected from the group consisting of nitrogen, argon, oxygen, helium, and CDA.

5. The method of claim 1, wherein the plasma is substantially free of fluorine.

6. The method of claim 1, wherein the plasma is generated at a power of at least about 300 watts.

7. A glass article made by the method of claim 1.

8. A method for treating a treating a glass article comprising a first major surface, a second major surface parallel to the first major surface, and an edge surface extending between the first major surface and the second major surface in a direction perpendicular to the first and second major surfaces, the method comprising:
directing a flow of plasma toward the first major surface, wherein direction of the flow of plasma toward the first major surface reduces the absolute measured voltage on the first major surface by at least about 35% and changes the average surface roughness, Ra, of the first major surface by less than about 20%.

9. The method of claim 8, wherein the flow of plasma comprises an atmospheric pressure plasma jet.

10. The method of claim 8, wherein the flow of plasma comprises an atmospheric pressure liner flow.

11. The method of claim 8, wherein the plasma comprises at least one component selected from the group consisting of nitrogen, argon, oxygen, helium, and CDA.

12. The method of claim 8, wherein the plasma is substantially free of fluorine.

13. The method of claim 8, wherein the plasma is generated at a power of at least about 300 watts.

14. A glass article made by the method of claim 8.

15. A glass article comprising a first major surface, a second major surface parallel to the first major surface, and an edge surface extending between the first major surface and the second major surface in a direction perpendicular to the first and second major surfaces, wherein an absolute measured voltage on the first major surface is less than about 0.25 kV and an average surface roughness, Ra, of the first major surface is less than about 0.3 nm.

16. An electronic device comprising the glass article of claim 15.
